(19) United States
(12) Patent Application Publication
(10) Pub. No.: US 2002/0029834 A1
(43) Pub. Date: Mar. 14, 2002

(54) Pneumatic tire

(75) Inventors: Hiroshi IIzuka, Hiratsuka-shi (JP); Hirokatsu Maruyama, Hiratsuka-shi (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: THE YOKOHAMA RUBBER CO., LTD.

(21) Appl. No.: 09/881,697

(22) Filed: Jun. 18, 2001

(30) Foreign Application Priority Data
Jun. 21, 2000 (JP) 2000-186772

(51) Int. Cl. B60C 11/00

(52) U.S. Cl. 152/209.16

(57) ABSTRACT

Disclosed is a pneumatic tire effectively controlling uneven wear occurring in the vicinity of a main groove even if a groove width of the main groove is widened due to change in tread radius during inflation. In the pneumatic tire, with regard to the main groove having the groove width widened during inflation among a plurality of main grooves provided on a tread surface, a groove wall near a shoulder is inclined outward in a tire width direction toward a groove bottom, and a thin rib protruding from the groove bottom along the groove wall near the shoulder is provided.

### BACKGROUND OF THE INVENTION

The present invention relates to a pneumatic tire provided with a plurality of main grooves extended in a tire circumferential direction on the tread surface. More particularly, the present invention relates to a pneumatic tire capable of controlling uneven wear occurring in the vicinity of the main grooves.

Generally, on the tread surface of the pneumatic tire, a single or plural curvature radius (tread radius), as a curvature, in a tire meridian direction is imparted based on the inner surface shape of a die mold. Meanwhile, in the pneumatic tire, the curvature radius on the tread surface tends to be changed during pressurization due to its inner structures such as a belt layer buried inside the tread portion, tread rubber and the like. When a change in curvature radius on the tread surface occurs in the above manner due to inflation, this change is absorbed by the groove portion, resulting in the occurrence of a phenomenon such as bending of the tread portion at the groove bottom as a boundary. Particularly, in a rib tire provided with a plurality of main grooves extended in the tire circumferential direction, the above bending phenomenon is significant.

As described above, when the tread portion is bent at the groove bottom as a boundary, the edge portion of the rib adjacent to the groove does not match the specified curvature radius of the tread surface, and the ground-contacting pressure on the rib edge portion is significantly changed. As a result, uneven wear occurs with the rib edge portion as a starting point, resulting in a growth of railway wear.

### SUMMARY OF THE INVENTION

The object of the present invention is to provide a pneumatic tire capable of effectively controlling uneven wear occurring in the vicinity of a main groove even in the case where the groove width of the main groove is widened due to a change in the tread radius during inflation.

A pneumatic tire of the present invention for achieving the foregoing object is a pneumatic tire provided with a plurality of main grooves extended in a tire circumferential direction on a tread surface, characterized in that, with regard to some of the main grooves among the foregoing plurality of main grooves whose groove width is widened during inflation, a groove wall near the shoulder is inclined outward in a tire width direction toward a groove bottom, and a thin rib protruding from the groove bottom along the groove wall near the shoulder is provided.

As described above, with regard to the main groove having the groove width widened due to the change in tread radius during inflation, by making the groove wall near the shoulder inclined outward in the tire width direction toward the groove bottom, it is made possible to control an increase in ground-contacting pressure of the rib edge portion including the groove wall near the shoulder. Moreover, by providing, in the foregoing main groove, the thin rib protruding from the groove bottom along the groove wall near the shoulder, it is made possible to absorb, into the thin rib, frictional energy acting so as to cause uneven wear on the rib edge portion including the groove wall near the shoulder. Hence, uneven wear such as railway wear occurring in the vicinity of the main groove can be effectively controlled by the synergy of the inclined structure of the groove wall near the shoulder and the thin rib.

In the present invention, it is satisfactory if the groove wall near the center of the main groove having a groove width widened during inflation is inclined outward in the tire width direction toward the groove bottom. Moreover, if the height of the thin rib is made equal to or lower than the foregoing tread surface with a height difference between the top face of the foregoing thin rib and the foregoing tread surface ranging from 0 to 4 mm, the absorption effect of the frictional energy by the thin rib can be increased during the initial wear.

### BRIEF DESCRIPTION OF THE DRAWINGS

For a more complete understanding of the present invention and the advantages thereof, reference is now made to the following description taken in conjunction with the accompanying drawings.

FIG. 1 is a cross-sectional view taken along a meridian direction, showing a pneumatic tire according to an embodiment of the present invention.

FIG. 2 is a development view showing a tread pattern of the pneumatic tire according to the embodiment of the present invention.

FIG. 3 is an enlarged cross-sectional view showing principal portions of the pneumatic tire according to the embodiment of the present invention.

### DETAILED DESCRIPTION OF THE PREFERRED EMBODIMENTS

Hereinbelow, description will be made in detail for the constitution of the present invention with reference to the accompanying drawings.

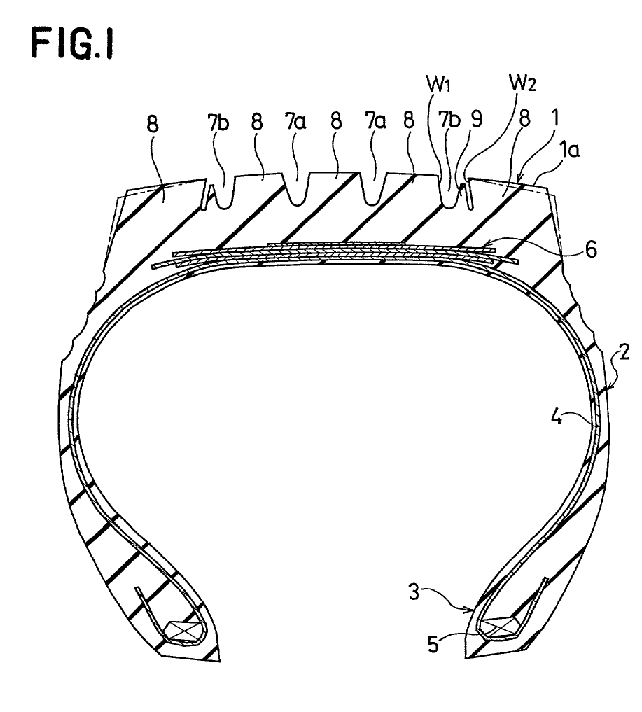

FIG. 1 shows a pneumatic tire according to an embodiment of the present invention. A reference numeral 1 denotes a tread portion; a numeral 2 denotes a side wall portion; and a numeral 3 denotes a bead portion. Between a right-and-left pair of bead portions 3 and 3, a carcass layer 4 is bridged, and both end portions thereof in a tire width direction are wound up around bead cores 5, respectively from the tire inner side to the tire outer side. At the outer circumference side of the carcass layer 4 in the tread portion 1, a plurality of belt layers 6 are buried.

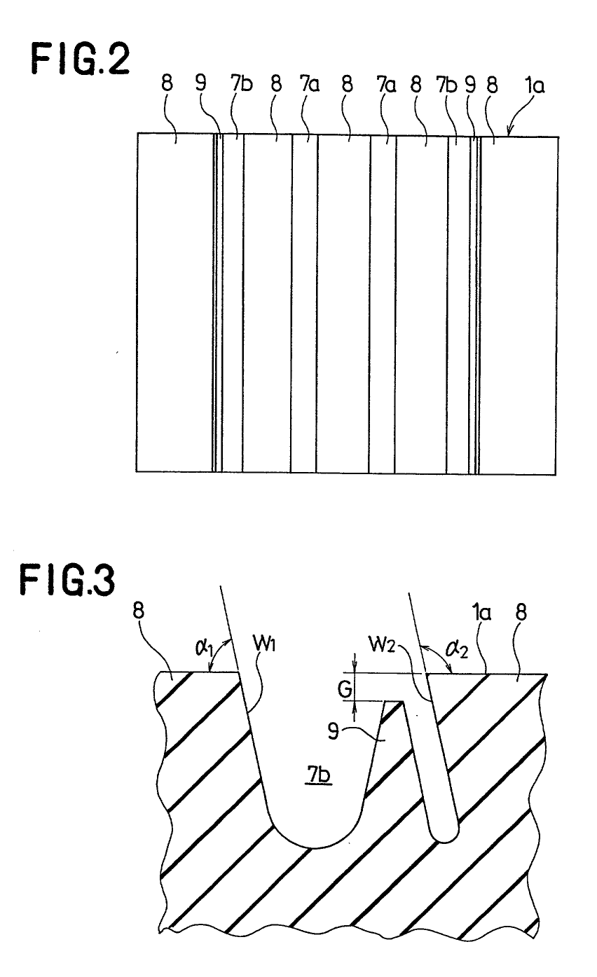

As shown in FIG. 2, on a tread surface 1a, a plurality of main grooves 7a and 7b composed of straight grooves extended in the tire circumferential direction are formed. The main groove 7a is located at the tread center side, and the main groove 7b is located more to the shoulder side than the main groove 7a. These main grooves 7a and 7b define the plural columns of ribs 8. It should be noted that side grooves, sipes and the like, which are extended in the tire width direction, may be provided on the tread surface 1a according to needs.

In the above pneumatic tire, due to the inner structure such as the belt layer 6 buried inside the tread portion 1, tread rubber and the like, the curvature radius of the tread surface 1a is changed during inflation, and the tread portion 1 is bent mainly at the groove bottom of the main groove 7b on the shoulder side as a boundary. As a result, the groove width of the main groove 7b is slightly widened compared to that before the inflation. It is possible to intentionally design the tire inner structure causing such a bending phenomenon based on the belt layer 6, the tread rubber and the like. For example, if the circumferential rigidity in the vicinity of the tread shoulder is relatively increased, growth of the outer circumference in the vicinity of the center is relatively increased during the inflation.

In the main groove 7b having the groove width widened during the inflation, the groove wall W₁ near the center is inclined outward in the tire width direction toward the groove bottom, and the groove wall W₂ near the shoulder is inclined outward in the tire width direction toward the groove bottom. More specifically, as shown in FIG. 3, an inclination angle α₁ of the groove wall W₁ near the center with respect to the tread surface 1a is smaller than 90°, and an inclination angle α₂ of the groove wall W₂ near the shoulder with respect to the tread surface 1a is larger than 90°. Moreover, inside the main groove 7b, the thin rib 9 protruding from the groove bottom is provided so as to be extended in the tire circumferential direction, and the thin rib 9 is constituted to be along the groove wall W₂ near the shoulder while being close thereto. It is recommended that a space between the thin rib 9 and the groove wall W₂ near the shoulder be set to 4 mm or smaller.

As shown by a chain and dotted line of FIG. 1, in the above pneumatic tire, the tread portion 1 is bent mainly at the groove bottom of the main groove 7b on the shoulder side as a boundary during the inflation, and the groove width of the main groove 7b is slightly widened compared to that before the inflation. Therefore, the ground-contacting pressure on the rib edge portion continuous with the groove wall W₂ near the shoulder in the main groove 7b tends to be increased. However, since the groove wall W₂ near the shoulder in the main groove 7b is inclined outward in the tire width direction toward the groove bottom as described above, and the rigidity of the rib edge portion is thus lowered, it is made possible to control the increase of the ground-contacting pressure in the rib edge portion continuous with the groove wall W₂ near the shoulder.

Moreover, since the thin rib 9 protruding from the groove bottom is provided along the groove wall W₂ near the shoulder, the thin rib 9 absorbs the frictional energy acting on the rib edge portion continuous with the groove wall W₂ near the shoulder. Therefore, uneven wear such as railway wear occurring in the vicinity of the main groove 7b can be effectively controlled by the synergy of the inclined structure of the groove wall W₂ near the shoulder and the thin rib 9.

In the above pneumatic tire, the height of the thin rib 9 is made equal to or lower than the tread surface 1a, and a height difference G therebetween is set in a range from 0 to 4 mm. By setting the height difference G between the top face of the thin rib 9 and the tread surface 1a in the above range, the absorption effect of the frictional energy by the thin rib 9 can be increased during the initial wear. If the height difference G exceeds 4 mm, the frictional energy cannot be absorbed during the initial wear, thus facilitating the uneven wear to occur, and it may result in a growth of railway wear as the wear progresses.

In the present invention, with regard to the main groove having a groove width widened during the inflation, the groove wall must be inclined outward in the tire width direction toward the groove bottom, and the thin rib protruding from the groove bottom along the groove wall near the shoulder must be provided. In addition to the above constitution, the groove wall near the center may be inclined inward in the tire width direction toward the groove bottom, and the thin rib protruding from the groove bottom along the groove wall near the center may be provided.

The present invention is extremely effective in the case where the main groove having a groove width widened during inflation is a straight groove; however, the present invention can also be applied to a main groove extended in the tire circumferential direction in zigzags. Moreover, the number of main grooves provided on the tread surface is not particularly limited, and it is satisfactory if the groove width of some of the main grooves is widened during the inflation.

### EXAMPLE

Tires of the present invention and conventional tires, which have the same tire size of 295/75R22.5 and different tread patterns, were produced.

Tire of the Present Invention:

As shown in FIG. 1, in the pneumatic tire provided with a plurality of main grooves extended in the tire circumferential direction on the tread surface, with regard to the main grooves having the groove width widened during inflation, the inclination angle α₁ of the groove wall near the center with respect to the tread surface is set at 80°, the inclination angle α₂ of the groove wall near the shoulder with respect to the tread surface is set at 100°, the thin rib protruding from the groove bottom along the groove wall near the shoulder is provided, and the height difference between the top face of the thin rib and the tread surface is set to 4 mm.

Conventional Tire:

In FIG. 1, the inclination angles α₁ and α₂ of the both groove walls of the main groove whose width is widened during inflation, with respect to the tread surface are respectively set at 80°, and the thin rib is not provided in the main groove.

Uneven wear property of these test tires was evaluated. As a method for evaluating the uneven wear property, two pieces of either the tires of the present invention or the conventional tires were attached as front tires to each of eight trucks, and were made to run mainly on a highway for a hundred thousand kilometers. Thereafter, occurrence of the uneven wear on the tread surface of each tire was observed.

As a result, with regard to the conventional tires, the railway wear occurred in four tires among sixteen tires. On the other hand, with regard to the tires of the present invention, the railway wear occurred only in one tire among sixteen tires.

As described above, according to the present invention, in the pneumatic tire provided with the plurality of main grooves extended in the tire circumferential direction on the tread surface, even if the groove width of the main grooves is widened due to the change in tread radius during inflation, the uneven wear occurring in the vicinity of the main grooves can be effectively controlled.

Although the preferred embodiment of the present invention has been described in detail, it should be understood that various changes, substitutions and alternations can be made therein without departing from spirit and scope of the inventions as defined by the appended claims.

What is claimed is:

1. A pneumatic tire provided with a plurality of main grooves extended in a tire circumferential direction on a tread surface, wherein, with regard to a main groove having a groove width widened during inflation among said plurality of main grooves, a groove wall near a shoulder is inclined outward in a tire width direction toward a groove bottom, and a thin rib protruding from the groove bottom along the groove wall near the shoulder is provided.

2. The pneumatic tire according to claim 1, wherein, with regard to said main groove having the groove width widened during inflation, a groove wall near the center is inclined outward in the tire width direction toward the groove bottom.

3. The pneumatic tire according to claim 1, wherein a height of said thin rib is made equal to or lower than said tread surface, and a height difference between a top face of said thin rib and said tread surface is set in a range of 0 to 4 mm.

4. The pneumatic tire according to claim 1, wherein a space between said thin rib and said groove wall near the shoulder is set to 4 mm or smaller.

5. The pneumatic tire according to any one of claims 1 to 4, wherein said main groove having the groove width widened during the inflation is a straight groove.
